(19) United States
(12) Patent Application Publication
(10) Pub. No.: US 2016/0172684 A1
(43) Pub. Date: Jun. 16, 2016

(54) SOLID OXIDE FUEL CELL MANUFACTURING METHOD FOR SOLID OXIDE FUEL CELL

(71) Applicant: MITSUBISHI HITACHI POWER SYSTEMS, LTD., Yokohama-shi (JP)

(72) Inventors: Kenichi Hiwatashi, Kanagawa (JP); Shin Yoshida, Kanagawa (JP); Hiroshi Tsukuda, Tokyo (JP)

(73) Assignee: MITSUBISHI HITACHI POWER SYSTEMS, LTD., Yokohama-shi (JP)

(21) Appl. No.: 14/957,017

(22) Filed: Dec. 2, 2015

(30) Foreign Application Priority Data
Dec. 10, 2014 (JP) 2014-249720

(51) Int. Cl. H01M 4/86; H01M 8/12; H01M 4/88

(52) U.S. Cl. CPC H01M 4/8673; H01M 4/881; H01M 8/1213; H01M 8/124; H01M 2008/1293; H01M 2300/0074

(57) ABSTRACT

The invention provides a solid oxide fuel cell having a cathode which uses a material that exhibits minimal variation in the linear expansion coefficient and has superior conductivity and catalytic activity, and also provides a manufacturing method for the solid oxide fuel cell. The solid oxide fuel cell has single fuel cells comprising an anode, a solid electrolyte membrane and a cathode, wherein at least a portion of the cathode comprises a perovskite oxide represented by La_{y}(Ni₁₋ₓFeₓ)O₃ (wherein 0.1≦x≦0.5 and 0.95≦y<1) as the main component.

### TECHNICAL FIELD

The present invention relates to a solid oxide fuel cell and a manufacturing method therefor, and relates particularly to a cathode.

### BACKGROUND ART

Examples of known solid oxide fuel cells include tubular solid oxide fuel cells and planar solid oxide fuel cells. For example, in a tubular solid oxide fuel cell, a plurality of tubular shaped cell stacks are connected electrically in parallel and housed inside the interior of the fuel cell. In each cell stack, a plurality of single fuel cells are formed, each comprising, for example, an anode, a solid electrolyte membrane and a cathode stacked on a porous substrate tube formed from calcia-stabilized zirconia (CSZ), with adjacent single fuel cells linked via an interconnector.

The anode is composed of a material prepared by mixing nickel and a zirconia-based electrolyte material such as yttria-stabilized zirconia (YSZ). YSZ is mainly used for the solid electrolyte membrane.

The cathode is composed of an LaMnO₃-based oxide. For example, Patent Literature 1 (PTL 1) discloses a cathode having a two-layer structure, wherein a cathode (cathode conductive layer) comprising a perovskite oxide represented by La_{(a+b)/2}Sr_{(1-a)/2}Ca_{(1-b)/2} Mn_{y}O₃ (wherein y>1, 0.4≦a≦0.8 and 0.4≦b≦0.8) as the main component is formed on the surface.

The operating temperature of a solid oxide fuel cell is generally about 1,000° C., but solid oxide fuel cells capable of operating at lower temperatures (for example, about 800° C. or lower) are being sought. However, because LaMnO₃-based oxides have low electrical conductivity at low temperatures of 800° C. or lower, if the operating temperature is reduced from 1,000° C. to 800° C. or lower, then the electrode reactivity and the mass transfer rate deteriorate, resulting in a reduction in the power generation performance.

In those cases where power generation is achieved using a cartridge containing a plurality of integrated cell stacks, a temperature distribution develops inside the cartridge. If the operating temperature is set to 800° C., then a temperature distribution from 650° C. to 900° C. develops inside the cartridge. In other words, cells exist in which power generation is performed at a temperature even lower than the set operating temperature, which has a significant effect on the power generation performance.

In light of these circumstances, a material that exhibits a high electrical conductivity at low temperatures is required for the cathode material, in order to prevent deterioration in the performance caused by a decrease in the operating temperature.

Moreover, it is also desirable that the cathode material has a linear expansion coefficient similar to that of the solid electrolyte membrane. This prevents damage to the membrane due to exposure to thermal cycles between room temperature and the operating temperature.

PTL 2 and PTL 3 disclose the use of lanthanum iron nickel oxides as cathode materials having a high conductivity at low temperatures and excellent catalytic activity. PTL 2 discloses an oxide with a perovskite structure represented by Ln(Ni₁₋ₓFeₓ)O₃ (wherein Ln represents a rare earth element, and x is a number from 0.30 to 0.60). PTL 3 discloses a perovskite oxide represented by Ln_{1-Y}A_{Y}Ni_{1-X}Fe_{X}O₃ (wherein Ln represents one or more elements selected from among La, Pr, Nd and Sm, A represents one or more elements selected from among Sr, Ba and Ca, X−0.2≦Y≦X−0.4, and 0.55≦X≦0.90).

### PRIOR ART LITERATURE

### Patent Literature

[PTL 1] Japanese Unexamined Patent Application, Publication No. 2013-140737

[PTL 2] Publication of Japanese Patent No. 3,414,657

[PTL 3] Publication of Japanese Patent No. 3,617,814

### SUMMARY OF INVENTION

### Problems to be Solved by the Invention

The material disclosed in PTL 2 has low sintering character, and is not adequately sintered at the cathode sintering temperature (about 1,200° C.). As a result, the cathode of PTL 2 exhibited an increased contact resistance and low power generation efficiency. In PTL 2, because the sintering of the cathode was inadequate, detachment caused by thermal cycling was a problem.

The material disclosed in Patent Document 3 exhibits favorable sintering character. However, the material of PTL 3 exhibits a rapid increase in the linear expansion coefficient at temperatures of 600° C. or higher. Accordingly, problems due to delamination or damage of the cathode tended to occur during operation of the fuel cell or upon starting and stopping of the cell.

The present invention has an object of providing a solid oxide fuel cell having a cathode which uses a material that exhibits minimal variation in the linear expansion coefficient from room temperature to the operating temperature range, and has superior conductivity and catalytic activity, as well as providing a manufacturing method for the solid oxide fuel cell.

### Solution to Problems

A first aspect of the present invention is a solid oxide fuel cell having single fuel cells comprising an anode, a solid electrolyte membrane and a cathode, wherein at least a portion of the cathode comprises a perovskite oxide represented by La_{y}(Ni₁₋ₓFeₓ)O₃ (wherein 0.1≦x≦0.5 and 0.95≦y<1) as the main component.

A second aspect of the present invention is a manufacturing method for a solid oxide fuel cell having single fuel cells comprising an anode, a solid electrolyte membrane and a cathode, the manufacturing method comprising a step of forming the anode and the solid electrolyte membrane, and a step of forming the cathode on the solid electrolyte membrane, wherein the step of forming the cathode comprises a step of applying a slurry containing a perovskite oxide represented by La_{y}(Ni₁₋ₓFeₓ)O₃ (wherein 0.1≦x≦0.5 and 0.95≦y<1) as the main component for at least a portion of the cathode.

The perovskite oxide represented by La_{y}(Ni₁₋ₓFeₓ)O₃ (wherein 0.1≦x≦0.5 and 0.95≦y<1) exhibits high conductivity and superior catalytic activity in the fuel cell operating temperature range from about 650° C. to 900° C. Provided the ratio between Ni and Fe satisfies the above range, there is minimal variation in the linear expansion coefficient from room temperature through to high temperatures (for example, 1,000° C.), and the difference in linear expansion from that of the underlying layer is small. As a result, detachment of the cathode during production and adhesion faults that occur when thermal cycling is performed can be prevented.

The oxide described above has an La-deficient non-stoichiometric composition. In the case of excess La, La₂O₃ is produced by sintering, and inhibits the sintering process. Further, in the case of excess La, La₂O₃ reacts with water vapor to generate La(OH)₃, which forms as a powder and lowers the film strength. Provided an La deficiency exists, a cathode having excellent sintering character and strength can be formed. On the other hand, as the amount of La decreases, free Ni and Fe are released from the perovskite structure. When the fuel cell is operated for a long period, this free Ni and Fe diffuses into the intermediate layer of the cathode, causing a deterioration in the catalytic activity of the cathode. By ensuring that y satisfies the range described above, any deterioration in the catalytic activity can be suppressed.

In the first aspect, the cathode may be composed of a cathode intermediate layer formed on the solid electrolyte membrane, and a cathode conductive layer formed on the cathode intermediate layer, wherein the cathode conductive layer comprises the aforementioned perovskite oxide as the main component.

In such a case, the cathode intermediate layer preferably comprises a ceria compound represented by Ln_{1-z}Ce_{z}O₂ (wherein Ln represents any one of Sm, Gd and La, and when Ln represents Sm or Gd, z satisfies 0.8≦z≦0.9, whereas when Ln represents La, z satisfies 0.5≦z≦0.8) as the main component.

In the second aspect, the step of forming the cathode may comprise a step of forming a cathode intermediate layer on the solid electrolyte membrane, and a step of forming a cathode conductive layer on the cathode intermediate layer, wherein the step of forming the cathode conductive layer comprises a step of applying a slurry containing the aforementioned perovskite oxide as the main component.

In such a case, the step of forming the cathode intermediate layer preferably involves applying a slurry containing a ceria compound represented by Ln_{1-z}Ce_{z}O₂ (wherein Ln represents any one of Sm, Gd and La, and when Ln represents Sm or Gd, z satisfies 0.8≦z≦0.9, whereas when Ln represents La, z satisfies 0.5≦z≦0.8) as the main component to the solid electrolyte membrane.

The ceria compound described above has excellent catalytic activity. In this manner, by forming a layer (the cathode intermediate layer) comprising the ceria compound as the main component between a layer (the cathode conductive layer) comprising the aforementioned perovskite oxide as the main component and the solid electrolyte membrane, superior power generation performance can be achieved.

### Effects of Invention

According to the present invention, the cathode can be sintered satisfactorily during production of a solid oxide fuel cell, and detachment can be suppressed.

During operation of the solid oxide fuel cell, because the cathode has a high conductivity and superior catalytic activity, and because no material degradation occurs, a high level of power generation performance can be maintained. Because detachment damage to the cathode caused by thermal cycling can be prevented, a solid oxide fuel cell having excellent durability can be obtained.

### BRIEF DESCRIPTION OF DRAWINGS

FIG. 1 is a partial cross-sectional view of a cell stack of a fuel cell according to one embodiment.

FIG. 2 is a graph illustrating the linear expansion coefficient for La_{y}(Ni₁₋ₓFeₓ)O₃ (y=0.98) upon variation in the value of x.

FIG. 3 illustrates performance test results for solid oxide fuel cells in which the cathode is formed using La_{y}(Ni₁₋ₓFeₓ)O₃ having various values for x.

FIG. 4 illustrates performance test results for solid oxide fuel cells in which the cathode is formed using La_{y}(Ni₁₋ₓFeₓ)O₃ having various values for y.

### EMBODIMENTS FOR CARRYING OUT THE INVENTION

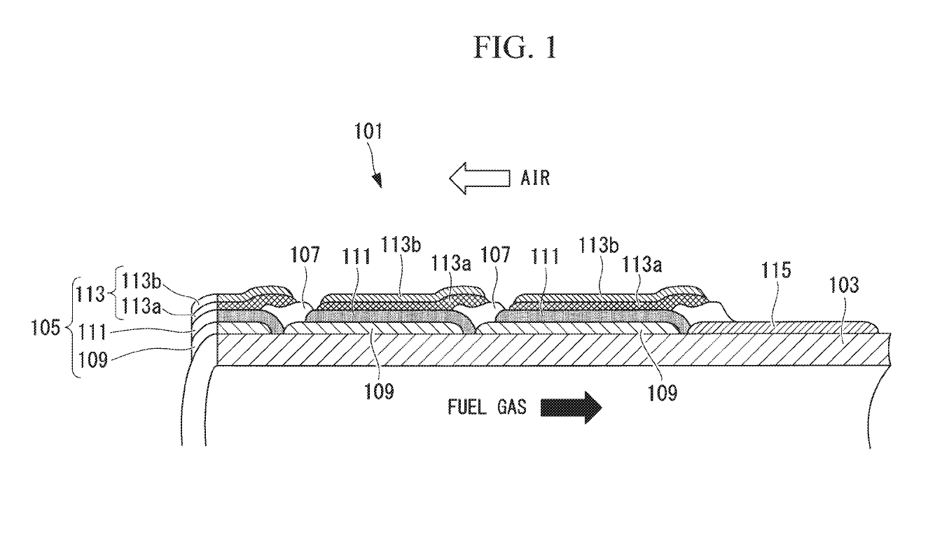

FIG. 1 illustrates one embodiment of a cell stack of a tubular fuel cell. The tubular fuel cell houses a plurality of cell stacks 101 of the present embodiment inside a power generation chamber. However, the case in which a single cell stack 101 is housed in the chamber can also be employed. In the present embodiment, the cell stack is described as having a tubular shape (in which the substrate has a circular cylindrical shape), but the invention is not limited to this configuration. For example, each cell stack may have an elliptical shape (in which the substrate has an elliptic cylindrical shape) or a planar shape (in which the substrate is planar). Moreover, the cell stack may not have a separate substrate, with the electrode also functioning as the substrate.

The cell stack 101 has a tubular substrate tube 103, a plurality of single fuel cells 105 formed on the outer peripheral surface of the substrate tube (substrate) 103, and interconnects 107 formed between adjacent single fuel cells 105. Each of the single fuel cells 105 is formed by stacking an anode 109, a solid electrolyte membrane 111 and a cathode 113. In the cell stack 101, among the plurality of single fuel cells 105 formed on the outer peripheral surface of the substrate tube 103, the cathodes 113 of the single fuel cells 105 formed at the ends of the substrate tube 103 in the axial direction are each connected electrically via an interconnector 107 to a lead film 115.

A fuel gas is introduced into the interior of the substrate tube 103 from one end of the substrate tube 103, and is discharged externally from the other end of the substrate tube 103. Meanwhile, an oxidant gas containing oxygen (for example, air) is supplied to the exterior of the substrate tube 103. The fuel gas supplied through the substrate tube 103 is, for example, a reformed gas of hydrogen (H₂) and carbon monoxide (CO) prepared by reacting a mixed gas of methane (CH₄) and steam. The anode 109 performs an electrochemical reaction, in the vicinity of the interface with the solid electrolyte membrane 111, between the hydrogen (H₂) and carbon monoxide (CO) obtained by reformation and oxygen ions (O²⁻) supplied through the solid electrolyte membrane 111, thereby generating water (H₂O) and carbon dioxide (CO₂). At this time, the single fuel cell 105 generates electrical power via the electrons released from the oxygen ions.

The substrate tube 103 is formed from a porous material, examples of which include CaO-stabilized ZrO₂ (CSZ), mixtures of CSZ and nickel oxide (NiO) (CSZ+NiO), Y₂O₃-stabilized ZrO₂ (YSZ), MgAl₂O₄ and SrZrO₃. This substrate tube 103 supports the single fuel cells 105, the interconnectors 107 and the lead films 115, and also allows diffusion of the fuel gas supplied to the inner peripheral surface of the substrate tube 103 through the pores of the substrate tube 103 to the anodes 109 formed on the outer peripheral surface of the substrate tube 103.

The anode 109 is composed of an oxide of a composite material of Ni and a zirconia-based electrolyte material. For example, Ni—YSZ may be used as the material for the anode.

The solid electrolyte membrane 111 mainly uses YSZ, which exhibits favorable air-tightness preventing the transmittance of gas, and also has excellent oxygen ion conductivity at high temperatures. This solid electrolyte membrane 111 transfers the oxygen ions (O²⁻) generated at the cathode to the anode.

The interconnector 107 is composed of a conductive perovskite oxide represented by M₁₋ₓLₓTiO₃ (wherein M represents an alkaline earth metal element, and L represents a lanthanide element) such as an SrTiO₃ system, and is a dense film that prevents mixing of the fuel gas and the oxidant gas. The interconnector 107 has stable electrical conductivity under both oxidizing atmospheres and reducing atmospheres. Each of these interconnectors 107 electrically connects the cathode 113 of one single fuel cell 105 with the anode 109 of an adjacent single fuel cell 105, thereby connecting the adjacent single fuel cells 105 in series.

The cathode 113 dissociates the oxygen in the supplied oxidant gas such as air to generate oxygen ions (O²⁻) in the vicinity of the interface with the solid electrolyte membrane 111.

At least a portion of the cathode 113 is composed of a layer comprising a perovskite oxide represented by La_{y}(Ni₁₋ₓ Feₓ)O₃ (wherein 0.1≦x≦0.5 and 0.95≦y<1) as the main component. For example, in the structure illustrated in FIG. 1, the cathode 113 has a two-layer configuration comprising a cathode intermediate layer 113a and a cathode conductive layer 113b formed on top of the cathode intermediate layer 113a. The cathode conductive layer 113b is a layer comprising the above perovskite oxide as the main component. The reasons for restricting the composition of the perovskite oxide are outlined below.

The cathode intermediate layer 113a is composed mainly of a ceria compound doped with a rare earth element. Specifically, the ceria compound may be represented by Sm_{1-z} Ce_{z}O₂ (wherein 0.8≦z≦0.9), Gd_{1-z}Ce_{z}O₂ (wherein 0.8≦z≦0.9), or La_{1-z}Ce_{z}O₂ (wherein 0.5≦z≦0.8). Ceria compounds of the above composition exhibit superior ion conductivity and excellent catalytic activity.

The lead film 115 performs the role of externally extracting the electricity generated in the cell stack 101. The lead film 115 is formed from the same material as the anode 109.

The step of forming the cell stack 101 described above is described below.

The substrate tube 103 may be formed, for example, by an extrusion molding method. The diameter of the substrate tube 103 is substantially uniform along the axial direction of the tube.

The anodes 109 are formed on the substrate tube 103 by a screen printing method. For example, a mixed powder of the anode material (Ni+YSZ) and an organic vehicle (prepared by adding a dispersant and a binder to an organic solvent) are first mixed together to prepare an anode slurry. This anode slurry is applied around the circumferential direction of the outer peripheral surface of the substrate tube 103 in prescribed positions corresponding with the single fuel cells 105 with a prescribed gap provided therebetween. The mixing ratio of the powder is selected appropriately in accordance with the performance required of the anodes 109. The mixing ratio between the mixed powder and the organic vehicle is selected appropriately with due consideration of factors such as the desired thickness for the anodes 109 and the state of the film following application of the slurry.

The lead films 115 are formed on the substrate tube 103 by a screen printing method. The anode slurry described above can be used as the slurry for the lead films 115. In those cases where a different material from the anode is used, the lead film slurry can be prepared by mixing a powder of the lead film material and an organic vehicle.

Following formation of the anodes 109, the solid electrolyte membranes 111 are formed on the outside surfaces of the anodes 109 and on the substrate tube 103 in the spaces between adjacent anodes 109 using a screen printing method. For example, a powder of the solid electrolyte membrane 111 and the aforementioned organic vehicle are mixed together to prepare a solid electrolyte membrane slurry. The mixing ratio between the powder and the organic vehicle is selected appropriately with due consideration of factors such as the desired thickness for the solid electrolyte membranes 111 and the state and thickness of the film following application of the slurry.

The interconnectors 107 are formed on the substrate tube 103 by a screen printing method. For example, a powder of the material for the interconnectors and an organic vehicle are first mixed together to prepare an interconnector slurry. This interconnector slurry is applied around the circumferential direction of the outer peripheral surface of the substrate tube 103 in positions corresponding with the gaps between adjacent single fuel cells 105. The composition of the powder is selected appropriately in accordance with the performance required of the interconnectors. The mixing ratio between the powder and the organic vehicle is selected appropriately with due consideration of factors such as the state of the film following application of the slurry.

The slurry films of the anodes 109, the solid electrolyte membranes 111 and the interconnectors 107 formed on the substrate tube 103 are co-sintered in an open atmosphere. Specifically, the sintering temperature is set to a temperature from 1,350° C. to 1,450° C.

The cathode intermediate layers 113a are formed on the co-sintered substrate tube 103. For example, a powder of the material for the cathode intermediate layer and an organic vehicle are first mixed together to prepare a cathode intermediate layer slurry. This cathode intermediate layer slurry is applied to prescribed positions on the outside surfaces of the solid electrolyte membranes 111 and the interconnectors 107. The cathode intermediate layer slurry may be applied by screen printing, or may be applied using a dispenser. Application using a dispenser is performed by dripping liquid droplets of the slurry from a dispenser onto the rotating substrate tube 103. The mixing ratio between the powder and the organic vehicle is selected appropriately with due consideration of factors such as the desired thickness for the cathode intermediate layers 113a and the state and thickness of the film following application of the slurry.

The cathode conductive layers 113b are formed on top of the cathode intermediate layers 113a. For example, a powder of the material for the cathode conductive layer and an organic vehicle are first mixed together to prepare a cathode conductive layer slurry. This cathode conductive layer slurry is applied to prescribed positions on the solid electrolyte membranes 111 (on the outside surfaces of the cathode intermediate layers 113a in the configuration illustrated in FIG. 1). The cathode conductive layer slurry may be applied by screen printing, or may be applied using a dispenser in a similar manner to the cathode intermediate layer. The mixing ratio between the powder and the organic vehicle is selected appropriately with due consideration of factors such as the desired thickness for the cathode conductive layers 113b and the state and thickness of the film following application of the slurry.

The substrate tube 103 with the slurry film of the cathode intermediate layers 113a and the cathode conductive layers 113b formed thereon is sintered in an open atmosphere. Specifically, the sintering temperature is set to a temperature from 1,100° C. to 1,250° C. This sintering temperature is set to a lower temperature than the co-sintering temperature used following the formation of the anodes 109, the solid electrolyte membranes 111 and the interconnectors 107 on the substrate tube 103.

Next is a description of the reasons for restricting the ranges for x and y in the cathode conductive layer material represented by La_{y}(Ni₁₋ₓFeₓ)O₃.

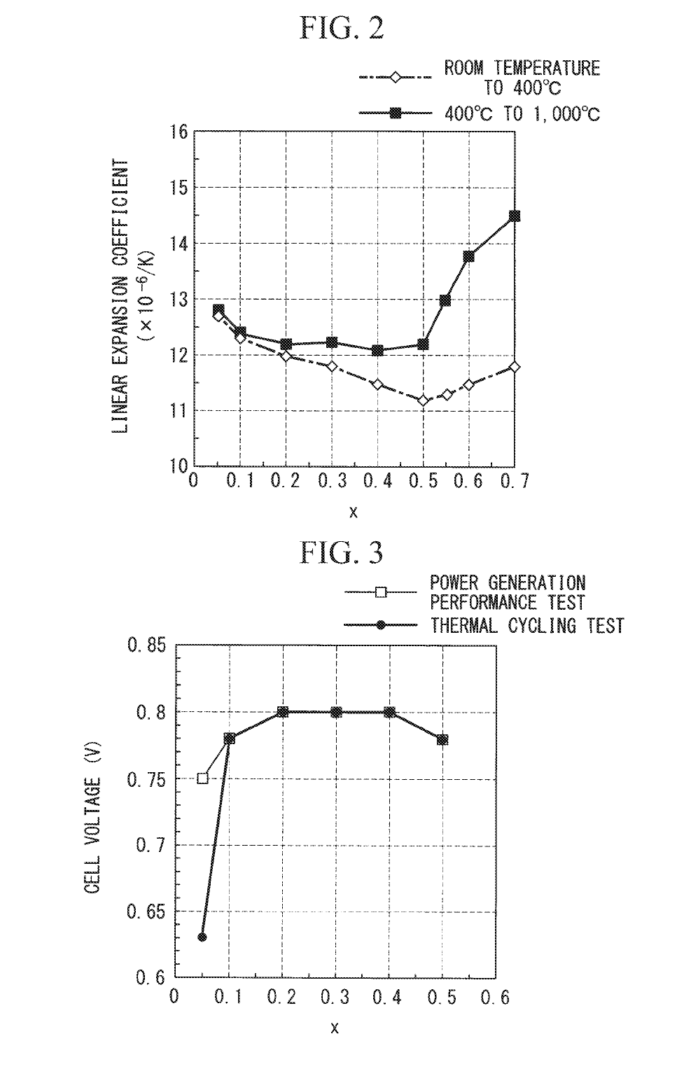

FIG. 2 is a graph illustrating the linear expansion coefficient for La_{y}(Ni₁₋ₓFeₓ)O₃ (y=0.98) upon variation in the value of x (the proportion of Ni and Fe). In the figure, the horizontal axis represents the numerical value of x, and the vertical axis represents the linear expansion coefficient. The numerical value for the linear expansion coefficient indicates either the average value within a temperature range from room temperature to 400° C., or the average value within a temperature range from 400° C. to 1,000° C.

FIG. 3 illustrates the results of power generation performance tests for solid oxide fuel cells in which the cathode has been formed using La_{y}(Ni₁₋ₓFeₓ)O₃ (y=0.98) having various values for x, and the results of power generation performance tests performed after a thermal cycling test. In the figure, the horizontal axis represents the numerical value of x, and the vertical axis represents the cell voltage.

The tests were performed under the following conditions.

### <Cell Stack Preparation Conditions>

Substrate tube: CSZ (amount of added Ca: 15 mol %)

Anode: composite material of Ni (amount of added Ni: 50 mol %) and YSZ (8 mol % of added Y₂O₃), anode thickness: 200 μm

Solid electrolyte membrane: YSZ (8 mol % of added Y₂O₃), solid electrolyte membrane thickness: 50 μm

Cathode intermediate layer: Sm_{0.1}Ce_{0.9}O₂, cathode intermediate layer thickness: 10 μm

Cathode conductive layer: La_{0.98}(Ni₁₋ₓFeₓ)O₃, cathode conductive layer thickness: 1,000 μm

Number of cells: 50

Cathode sintering temperature: 1,200° C.

### <Power Generation Performance Test>

Test temperature: 800° C. (±5° C.)

Current density: 0.3 A/cm²

Fuel: hydrogen gas

Fuel utilization rate: 60%

Oxidant gas: air

Air utilization rate: 20%

### <Thermal Cycling Test>

### Cycle Conditions:

(1) 800° C.→100° C. (temperature lowered at 100° C./hour) (temperature measured inside the power generation chamber near the center in the cell stack major axial direction)

(2) keep at 100° C. for 2 hours

(3) 100° C.→800° C. (temperature increased at 100° C./hour)

(4) keep at 800° C. for 2 hours

Number of cycles (number of repetitions of (1) to (4)): 20 cycles

Current density during cycling: 0 A/cm²

Fuel: 95% nitrogen+5% hydrogen

<Power Generation Performance Test after Thermal Cycling Test>

After the thermal cycling test described above, a power generation test was performed under the following conditions.

Test temperature: 800° C. (±5° C.)

Current density: 0.3 A/cm²

Fuel: hydrogen gas

Fuel utilization rate: 60%

Oxidant gas: air

Air utilization rate: 20%

As illustrated in FIG. 2, when the value of x exceeds 0.5, the linear expansion coefficient increases rapidly at high temperatures (from 400° C. to 1,000° C.). It is thought that this observation is due to the La_{y}(Ni₁₋ₓFeₓ)O₃ undergoing a phase transformation at about 600° C. When La_{y}(Ni₁₋ₓFeₓ)O₃ having an x value exceeding 0.5 was used, because the difference in linear expansion was large, the cathode conductive layer was damaged following firing, making it impossible to perform the power generation performance test and the thermal cycling test. As a result, in FIG. 3, there are no measurement points at x>0.5.

Referring to FIG. 3, it is evident that when x was less than 0.1, the cell voltage decreased in both the power generation performance test and the thermal cycling test compared with those cases where x was within a range from at least 0.1 to not more than 0.5. The decrease in the cell voltage was particularly marked following the thermal cycling test.

As illustrated in FIG. 2, when x is less than 0.1, the linear expansion coefficient increases at high temperatures. When x=0.05, the average linear expansion coefficient from room temperature to 400° C. is 12.7×10⁻⁶/K, and the average linear expansion coefficient from 400° C. to 1,000° C. is 12.8×10⁻⁶/K. In contrast, the average linear expansion coefficient of the underlying cathode intermediate layer (ceria compound) from room temperature to 400° C. is 9.5 to 10.0×10⁻⁶/K, and the average linear expansion coefficient from 400° C. to 1,000° C. is 10.0 to 10.5×10⁻⁶/K. In other words, when the value of x is small, the difference in linear expansion between the cathode intermediate layer and the cathode conductive layer increases. It is thought that because this difference in the linear expansion coefficient is large, the cathode is prone to damage, particularly in the thermal cycling test, resulting in a deterioration in the performance.

La_{y}(Ni₁₋ₓFeₓ)O₃ exhibits a low linear expansion coefficient and has good crystalline stability at both high temperatures and low temperatures when the value of x is within the range from at least 0.1 to not more than 0.5. As a result, damage such as detachment of the cathode is prevented, and a high cell voltage can be achieved in both the power generation performance test and the thermal cycling test.

The trends illustrated in FIG. 2 and FIG. 3 were able to be confirmed for the range represented by 0.95≦y<1.

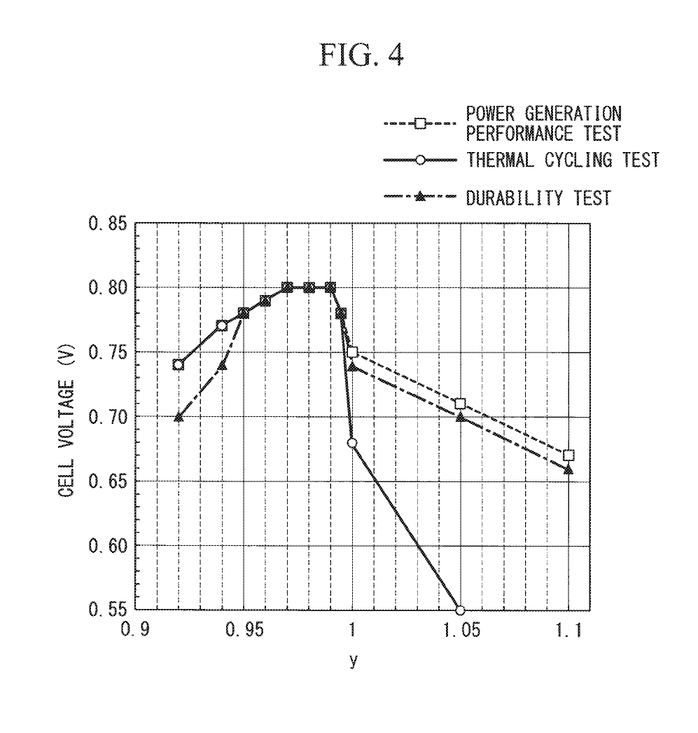

FIG. 4 illustrates performance test results for solid oxide fuel cells in which the cathode has been formed using La_{y}(Ni₁₋ₓFeₓ)O₃ (x=0.4) having various values for y. In the figure, the horizontal axis represents the numerical value of y, and the vertical axis represents the cell voltage.

With the exception of using La_{y}(Ni_{0.6}Fe_{0.4})O₃ for the cathode conductive layer, the cell stack used in acquiring FIG. 4 was prepared under the same conditions as those used in preparing the cell stack used in acquiring FIG. 3.

The power generation test conditions, the thermal cycling test conditions, and the conditions for the power generation performance test performed after the thermal cycling test were the same as those used in acquiring FIG. 3. A durability test was performed under the following conditions.

### <Durability Test>

Test temperature: 800° C. (±5° C.)

Current density: 0.3 A/cm²

Test time: 3,000 hours (continuous operation)

Fuel: hydrogen gas

Fuel utilization rate: 60%

Oxidant gas: air

Air utilization rate: 20%

As illustrated in FIG. 4, when y was 1 or greater, the cell voltage decreased in all the tests compared with the case where y satisfied 0.95≦y<1. In particular, the cell voltage following the thermal cycling test decreased dramatically as the value of y was increased. When y=1.1, the cathode conductive layer had detached after the thermal cycling test, and the cell voltage could not be measured.

It is thought that the reason the performance deteriorates when the value of y is 1 or greater is because in the sintering process during production, La₂O₃ is deposited at the crystal grain boundaries, thereby inhibiting the sintering process. When La₂O₃ makes contact with water vapor following sintering, it reacts with the water vapor to generate La(OH)₃. Because La(OH)₃ readily forms a powder, the film strength of the cathode conductive layer is poor. It is thought that, as a result, the cathode conductive layer is more likely to detach during testing, resulting in a deterioration in the performance. In particular, it is thought that the repeated heating and cooling in the thermal cycling test made the cathode conductive layer more likely to detach.

As illustrated in FIG. 4, a tendency for a deterioration in performance when the y value decreased was observed. In particular, when the value of y was less than 0.95, the cell voltage after the durability test decreased dramatically. It is thought that the reason for the marked deterioration in the durability is because when the amount of La is reduced, free Ni and Fe is more readily released from the perovskite structure, forming NiO and Fe₂O₃, which then diffuse into the cathode intermediate layer. It is surmised that the NiO and Fe₂O₃ which diffuses into the cathode intermediate layer then reacts with the material of the cathode intermediate layer (the ceria compound), reducing the three-phase interface and causing a deterioration in the catalytic activity.

Provided the cell voltage is at least 0.75 V, satisfactory power generation efficiency can be achieved. As illustrated in FIG. 4, in order to obtain a high cell voltage, it is preferable that y satisfies 0.95≦y≦0.995, and more preferably satisfies 0.97≦y≦0.99.

It was also confirmed that within the range represented by 0.1≦x≦0.5, similar trends to those illustrated in FIG. 4 were obtained.

### REFERENCE SIGNS LIST

101 Cell stack
103 Substrate tube
105 Single fuel cell
107 Interconnector
109 Anode
111 Solid electrolyte membrane
113 Cathode
113a Cathode intermediate layer
113b Cathode conductive layer
115 Lead film

1. A solid oxide fuel cell having a single fuel cell comprising an anode, a solid electrolyte membrane and a cathode, wherein
at least a portion of the cathode comprises a perovskite oxide represented by La_{y}(Ni₁₋ₓFeₓ)O₃ (wherein 0.1≦x≦0.5 and 0.95≦y<1) as a main component.

2. The solid oxide fuel cell according to claim 1, wherein
the cathode comprises a cathode intermediate layer formed on the solid electrolyte membrane, and a cathode conductive layer formed on the cathode intermediate layer, and
the cathode conductive layer comprises the perovskite oxide as a main component.

3. The solid oxide fuel cell according to claim 2, wherein
the cathode intermediate layer comprises, as a main component, a ceria compound represented by Ln_{1-z}Ce_{z}O₂ (wherein Ln represents any one of Sm, Gd and La, and when Ln represents Sm or Gd, z satisfies 0.8≦z≦0.9, and when Ln represents La, z satisfies 0.5≦z≦0.8).

4. A manufacturing method for a solid oxide fuel cell having a single fuel cell comprising an anode, a solid electrolyte membrane and a cathode, the manufacturing method comprising:
a step of forming the anode and the solid electrolyte membrane, and
a step of forming the cathode on the solid electrolyte membrane, wherein
the step of forming the cathode comprises a step of applying a slurry containing a perovskite oxide represented by La_{y}(Ni₁₋ₓFeₓ)O₃ (wherein 0.1≦x≦0.5 and 0.95≦y<1) as a main component for at least a portion of the cathode.

5. The manufacturing method for a solid oxide fuel cell according to claim 4, wherein
the step of forming the cathode comprises a step of forming a cathode intermediate layer on the solid electrolyte membrane, and a step of forming a cathode conductive layer on the cathode intermediate layer, and
the step of forming the cathode conductive layer comprises a step of applying a slurry containing the perovskite oxide as a main component.

6. The manufacturing method for a solid oxide fuel cell according to claim 5, wherein
in the step of forming the cathode intermediate layer, a slurry containing a ceria compound represented by Ln_{1-z}Ce_{z}O₂ (wherein Ln represents any one of Sm, Gd and La, and when Ln represents Sm or Gd, z satisfies 0.8≦z≦0.9, and when Ln represents La, z satisfies 0.5≦z≦0.8) as a main component is applied to the solid electrolyte membrane.
